(19) United States
(12) Patent Application Publication
(10) Pub. No.: US 2020/0108680 A1
(43) Pub. Date: Apr. 9, 2020

(54) Bumper Hitch Shin Guard

(71) Applicant: Jimmy Dean Locklear, Laurinburg, NC (US)

(72) Inventor: Jimmy Dean Locklear, Laurinburg, NC (US)

(21) Appl. No.: 16/153,754

(22) Filed: Oct. 6, 2018

(51) Int. Cl. B60D 1/60

(52) U.S. Cl. CPC B60D 1/60

(57) ABSTRACT

The present invention is a protective sheath designed to be attached to a trailer hitch ball mount. The apparatus provides protection to individuals moving around a vehicle fitted with a trailer hitch. It is decorative, requires no tools for installation and can be installed or removed while the trailer is attached.

### CROSS-REFERENCE TO RELATED APPLICATIONS

Specification is submitted as a substitute to an erroneous submission of documents pertaining to Application Ser. No. 16/153,754 filed on Oct. 6, 2018. There is new subject matter herein.

### STATEMENT REGARDING FEDERALLY SPONSORED RESEARCH OR DEVELOPMENT

There has been no federally sponsored research or development issued to the present invention

### THE NAMES OF THE PARTIES TO A JOINT RESEARCH AGREEMENT

No other parties involved in the conception or development of the present invention.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Application Ser. No. 16/153,754 submitted via EFS-WEB on Oct. 6, 2018

### STATEMENT REGARDING PRIOR DISCLOSURES BY THE INVENTOR OR A JOINT INVENTOR

I, Jimmy Dean Locklear, is the sole inventor

### BACKGROUND OF THE INVENTION

### (1) Field of the Invention

The embodiment herein relates to trailer hitches

### (2) Description of Related Art Including Information Disclosed under 37 CFR 1.97 and 1.98

The various trailer hitches; i.e. bumper mount, goose neck and fifth wheel; have evolved to accommodate vehicle type, larger payloads and provide a more stable tow. Larger vehicles and increased payload lengths require extended ball mounts. Ball mounts may extent more than 18 inches from the bumper.

Work trucks are often fitted with trailer hitches. Trailer hitches are low and out of the line of sight and are overlooked. Workers often move hastily around work trucks when getting tools and materials from the bed of the truck. The extended ball mount becomes a safety hazard.

The ball mount becomes an even more serious safety hazard when children are playing around a vehicle fitted with a trailer hitch. A ball mount struck by an adult would be on his or her shin. The point of contact struck by a child, depending on the height of the child, may be in a place that could cause serious bodily harm.

Therefore, a protective apparatus is clearly needed for trailer hitch ball mounts.

### BRIEF SUMMARY OF THE INVENTION

The problem stated above is that ball mounts are safety hazards. Therefore, a protective device is needed to prevent bodily harm. The embodiment is a cushioned apparatus that encases the lateral edge of the ball mount

### BRIEF DESCRIPTION OF THE SEVERAL VIEWS OF THE DRAWING(S)

FIG. 1 shows an extended ball mount with the ball attached.

FIG. 2 shows the contact side of the present invention, #1 and #2 of FIG. 2 show the attaching elements.

FIG. 3 Shows the present invention attached to the ball mount.

### DETAILED DESCRIPTION OF THE INVENTION

The present invention is an apparatus used to prevent bodily harm incurred from strikes the ball mount of a trailer hitch. The present invention consists of a cushioned, resilient material having a C shaped cross section that encases the lateral edges of a trailer hitch ball mount. An attaching element is also affixed to the apparatus for installation to the ball mount.

Embodiment 1: A cushioned material injected into a mold the shape of the lateral edges of the ball mount, with an element to attach the apparatus to the ball mount.

Embodiment 2: A cushioned material, inserted between resilient materials shaped the lateral edges of the ball mount, with an element to attach the apparatus to the ball mount.

A preferred attaching element would be a leather strap with Velcro™. However, buttons, snaps, strings or hooks would suffice.

1. A personal protective apparatus, consisting of cushioned, resilient materials fashioned to encase the lateral edges of a trailer hitch's ball mount.

2. An apparatus, according to claim 1, that has an element attached to be used to affix the apparatus to the ball mount
